(19) United States
(12) Patent Application Publication
(10) Pub. No.: US 2026/0050590 A1
(43) Pub. Date: Feb. 19, 2026

(54) COMMUNICATION NETWORK TOPOLOGY VISUALIZATION

(71) Applicant: AT&T Intellectual Property I, L.P., Atlanta, GA (US)

(72) Inventors: Chunhua Gao, Freehold, NJ (US); Christopher Gwaltney, St. Charles, MO (US); Kevin D'Souza, Yardley, PA (US); Leah Zhang, Holmdel, NJ (US); Isilay Baran, Morganville, NJ (US)

(21) Appl. No.: 18/805,428

(22) Filed: Aug. 14, 2024

(51) Int. Cl. H04L 41/22; H04L 41/02; H04L 41/0604

(52) U.S. Cl. CPC G06F 16/245

(57) ABSTRACT

A processing system including at least one processor may obtain a natural language request for a network topology visualization associated with a communication network. The processing system may next generate a prompt based upon the natural language request in accordance with a prompt mapping function, apply the prompt as an input to a generative model to generate a query, and apply the query to a communication network database system to obtain a query result. The processing system may generate the network topology visualization from the query result. The processing system may then present the network topology visualization via at least one display device.

The present disclosure relates generally to communication network operations, and more specifically to methods, computer-readable media, and apparatuses for generating a network topology visualization from a query result obtained via applying a query generated via a generative model from a prompt in accordance with a natural language request.

### BACKGROUND

A large communication network may collect and process a substantial volume of data generated by devices/systems. Such data may be primarily maintained in database tables, e.g., in a structured query language (SQL) or no-SQL format. In addition, tables, or rows and columns thereof may be associated or linked to one another to maintain additional knowledge in a graph database, and so forth.

### SUMMARY

The present disclosure describes methods, computer-readable media, and apparatuses for generating a network topology visualization from a query result obtained via applying a query generated via a generative model from a prompt in accordance with a natural language request. For instance, in one example, a processing system including at least one processor may obtain a natural language request for a network topology visualization associated with a communication network. The processing system may next generate a prompt based upon the natural language request in accordance with a prompt mapping function, apply the prompt as an input to a generative model to generate a query, and apply the query to a communication network database system to obtain a query result. In turn, the processing system may generate the network topology visualization from the query result. The processing system may then present the network topology visualization via at least one display device.

### BRIEF DESCRIPTION OF THE DRAWINGS

The present disclosure can be readily understood by considering the following detailed description in conjunction with the accompanying drawings, in which:

FIG. 1 illustrates an example of a system related to the present disclosure;

FIG. 2 illustrates an example process for generating a network topology visualization from a query result obtained via applying a query generated via a generative model from a prompt in accordance with a natural language request, in accordance with the present disclosure;

FIG. 3 illustrates an example user interface for network topology visualization, in accordance with the present disclosure;

FIG. 4 illustrates a flowchart of an example method for generating a network topology visualization from a query result obtained via applying a query generated via a generative model from a prompt in accordance with a natural language request; and

FIG. 5 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for generating a network topology visualization from a query result obtained via applying a query generated via a generative model from a prompt in accordance with a natural language request. In particular, examples of the present disclosure ingest natural language requests/prompts for network topology visualization, from which queries, or query statements, may be generated using generative artificial intelligence (AI) and/or machine learning (ML) (collectively referred to as generative AI, or genAI). In addition, examples of the present disclosure may process these generated queries over a communication network database system to obtain query results, and may further generate one or more network topology visualizations for display/presentation based upon the query results in accordance with the natural language requests/prompts.

Notably, legacy databases may be migrated to new platforms, e.g., cloud/network-based platforms, such as Snowflake, etc. In addition, more complex and/or new formats of data storage, such as Java Script Object Notation (JSON) or the like are increasingly being deployed. Typical communication network operation workflows may include examining and exploring network topologies, which may include first querying a database to extract relevant records, etc. For instance, the database records may include geographical network topology data, physical and logical connectivity data (including route data), connectivity measurement success and impairments, and so forth. This may involve significant time and effort for a user to manually construct a structured query/query statement. Examples of the present disclosure may standardize database queries and output network topology visualization processes using machine learning and generative artificial intelligence request/prompt enhancement as described herein. Examples of the present disclosure thus simplify network operations, e.g., eliminating complex, manual query construction. For instance, a user may obtain query-accessible data, and may have network topology visualizations generated and displayed based upon a human language request/prompt pertaining to network topology information and other network operational data in a network database system. In other words, a user without skills in Structured Query Language (SQL), graph query languages, or the like may easily perform queries by natural language (e.g., text and/or voice) request. In addition, examples of the present disclosure may reduce time and efforts to learn existing database and network topology visualization system languages, protocols, etc. and/or to develop new query and network topology visualization tools.

To further illustrate, examples of the present disclosure may provide for flexible choice of source database(s), data tables, etc. For instance, in one example, the present disclosure may provide an option to select Snowflake or comma-separated value (CSV) file formats, or other types of stored data. In one example, the present disclosure may be configured to work with different databases and/or database types, different roles, different data lakes or data warehouses, different schemas, different tables and/or table view, and so on. In any case, the present disclosure may then provide for automatic query generation and automated generation of network topology visualization(s) from human text request/prompt. In one example, the present disclosure may further provide for selection (e.g., via natural language as part of the initial request/prompt, or following obtaining a query result), generation, and display/presentation of a particular type of network topology visualization (e.g., a physical network map, a logical network map, a network route map comprising one or more network routes, a layer 2 network map, a layer 3 network map, a virtual private network (VPN) topology map, a network inventory map, a root cause network topology visualization, a network route impairment map illustrating a route between two endpoints that is impaired, a network topology visualization with at least one geographic map component/layer, a network topology visualization with at least one animation, and so forth).

In addition, examples of the present disclosure may comprise additional features of, or may otherwise be integrated with an AI/ML virtual assistant or knowledge base associated with a communication network. In one example, AL/ML elements of the present disclosure may be trained/updated on an ongoing basis via self-training/learning for optimized query generation and/or for optimized network topology visualization generation, e.g., via user feedback or other feedback. As discussed in greater detail below, examples of the present disclosure may also incorporate retrieval augmented generation (RAG) to update new learnings within the generative AI/ML ecosystem. In one example, recent requests, enhanced prompts, generated queries, and/or generated instructions for a network topology visualization tool/platform may be stored along with corresponding query results and/or corresponding network topology visualizations for streamlined response for repeat requests/queries.

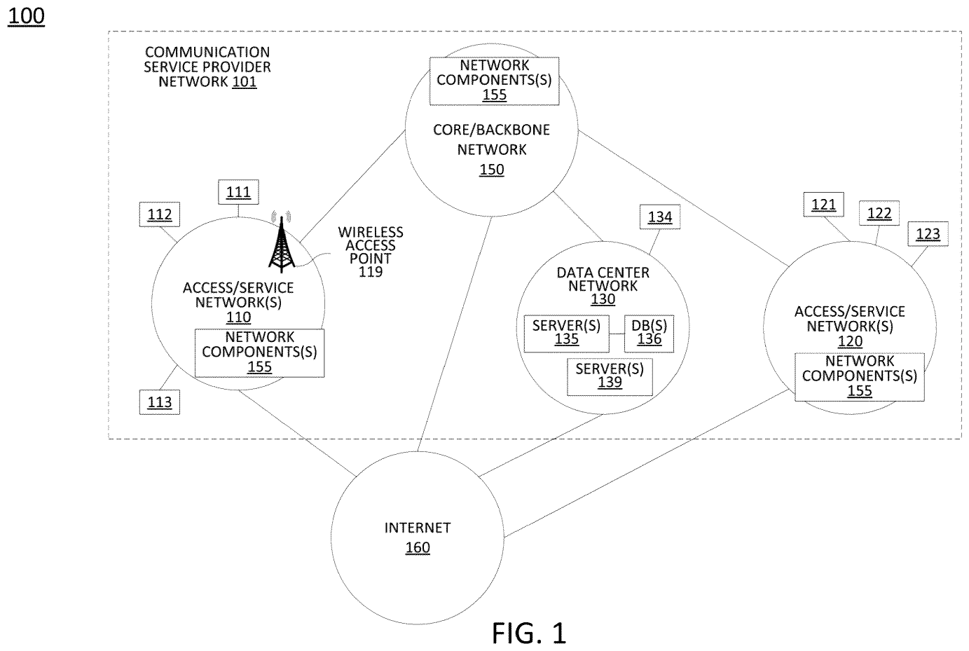

As such, examples of the present disclosure reduce development time and effort compared to existing applications. In addition, users may obtain network topology visualizations with little to no learning to operate a complex database system. It is again noted that a human language request from a user may be the only requisite input in order for the present disclosure to process and obtain a query and to automatically generate a corresponding network topology visualization based on such a result. Even for a user versed in one or more query languages (such as SQL, Gremlin, GraphQL, etc.) and/or one or more network topology visualization tools/suites, examples of the present disclosure may still save the user's time and effort to retrieve relevant network topology information or other network operational data, and to construct network topology visualizations from such data. In addition, in various examples, the present disclosure may be implemented using the current and/or future tools and technologies, such as using a LangChain framework with Snowflake application programming interface (API), large language model(s) (LLM(s) (such as OpenAI and others), Streamlit user interface (UI) implementation, and so forth. In one particular example, multiple data sources (e.g., for network topology information, other network operational data, etc.) and/or JSON format columns from Snowflake may be supported. These and other aspects of the present disclosure are discussed in greater detail below in connection with the examples of FIGS. 1-5.

To aid in understanding the present disclosure, FIG. 1 illustrates an example system 100 comprising a plurality of different networks in which examples of the present disclosure may operate. Communication service provider network 101 may comprise a core network and/or backbone network 150 with components for telephone services, Internet services, and/or video services (e.g., triple-play services, etc.) that are provided to customers (broadly “subscribers”), and to peer networks. In one example, core/backbone network 150 may combine core network components of a cellular network with components of a triple-play service network. For example, communication service provider network 101 may functionally comprise a fixed-mobile convergence (FMC) network, e.g., an IP Multimedia Subsystem (IMS) network. In addition, core/backbone network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication service provider network 101 may also further comprise a broadcast video network, e.g., a cable television provider network or an Internet Protocol Television (IPTV) network, as well as an Internet Service Provider (ISP) network. With respect to video/television service provider functions, core/backbone network 150 may include one or more video servers for the delivery of video content, e.g., a broadcast server, a cable head-end, a video-on-demand (VoD) server, and so forth. For example, core/backbone network 150 may comprise a video super hub office, a video hub office and/or a service office/central office.

In one example, access/service networks 110 and 120 may provide one or more services to subscribers and/or customer premises, such as voice, data, video, and/or wireless access services, virtual local area network (VLAN) services, and so forth. For instance, access/service networks 110 and 120 may each comprise a Digital Subscriber Line (DSL) network, a broadband cable access network, a Local Area Network (LAN), a cellular or non-cellular wireless access network, and the like. For example, access/service networks 110 and 120 may transmit and receive communications between endpoint devices 111-113, endpoint devices 121-123, and data center network 130, and between core/backbone network 150 and endpoint devices 111-113 and 121-123 relating to voice telephone calls, communications with web servers via the Internet 160, and so forth. Access/service networks 110 and 120 may also transmit and receive communications between endpoint devices 111-113, 121-123 and other networks and devices via Internet 160. In another example, one or both of the access/service networks 110 and 120 may comprise an ISP network external to communication service provider network 101, such that endpoint devices 111-113 and/or 121-123 may communicate over the Internet 160, without involvement of the communication service provider network 101. Endpoint devices 111-113 and 121-123 may each comprise customer premises equipment (CPE), user equipment (UE), and/or other endpoint device types, such as a telephone, e.g., for analog or digital telephony, a mobile device, such as a cellular smart phone, a laptop, a tablet computer, etc., a router (e.g., a customer edge (CE) router), a gateway, a desktop computer, a plurality or cluster of such devices, a television (TV), e.g., a “smart” TV, or a set-top box (STB).

In one example, the access/service networks 110 and 120 may be different types of access networks. In another example, the access/service networks 110 and 120 may be the same type of access network. In one example, one or more of the access/service networks 110 and 120 may be operated by the same or a different service provider from a service provider operating the communication service provider network 101. For example, each of the access/service networks 110 and 120 may comprise an Internet service provider (ISP) network, a cable access network, and so forth. In another example, each of the access/service networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where core/backbone network 150 may provide cellular core network functions, e.g., of a public land mobile network (PLMN)-universal mobile telecommunications system (UMTS)/General Packet Radio Service (GPRS) core network, or the like. For instance, access/service network(s) 110 may include at least one wireless access point (AP) 119, e.g., a cellular base station, such as an eNodeB, or gNB, a non-cellular wireless access point (AP), such as an Institute of Electrical and Electronics Engineers (IEEE) 802.11 (Wi-Fi) access point, or the like. In still another example, access/service networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access/service networks 110 or 120, which receives data from and sends data to the endpoint devices 111-113 and 121-123, respectively.

In this regard, it should be noted that in some examples, endpoint devices 111-113 and 121-123 may connect to access/service networks 110 and 120 via one or more intermediate devices, such as a home or enterprise gateway and/or router, e.g., where access/service networks 110 and 120 comprise cellular access networks, ISPs and the like, while in another example, endpoint devices 111-113 and 121-123 may connect directly to access/service networks 110 and 120, e.g., where access/service networks 110 and 120 may comprise local area networks (LANs), enterprise networks, and/or home networks, and the like.

In one example, communication service provider network 101 may also include one or more network components 155 (e.g., in core/backbone network 150 and/or access/service networks 110 and 120). Network components 155 may include various physical components of communication service provider network 101. For instance, network components 155 may include various types of optical network equipment, such as an optical network terminal (ONT), an optical network unit (ONU), an optical line amplifier (OLA), a fiber distribution panel, a fiber cross connect panel, and so forth. Similarly, network components 155 may include various types of cellular network equipment, such as a mobility management entity (MME), a mobile switching center (MSC), an eNodeB, a gNB, a base station controller (BSC), a baseband unit (BBU), a remote radio head (RRH), an antenna system controller, and so forth. In one example, network components 155 may alternatively or additionally include voice communication components, such as a call server, an echo cancellation system, voicemail equipment, a private branch exchange (PBX), etc., short message service (SMS)/text message infrastructure, such as an SMS gateway, a short message service center (SMSC), or the like, video distribution infrastructure, such as a media server (MS), a video on demand (VoD) server, a content distribution node (CDN), and so forth. Network components 155 may further include various other types of communication network equipment such as a layer 3 router, e.g., a provider edge (PE) router, an integrated services router, etc., an Internet exchange point (IXP) switch, and so on. In one example, network components 155 may further include virtual components, such as a virtual machine (VM), a virtual container, etc., software defined network (SDN) nodes, such as a virtual mobility management entity (vMME), a virtual serving gateway (vSGW), a virtual network address translation (NAT) server, a virtual firewall server, or the like, and so forth. In addition, in one example, network component 155 may include measurement systems, such as network probe devices or the like, to test connectivity across core/backbone network 150, access/service network(s) 110, and/or access/service network(s) 120 (e.g., end-to-end and/or within a selected network segment, etc.). In addition, for ease of illustration, various components of communication service provider network 101 are omitted from FIG. 1.

Still other network components 155 may include a database of assigned telephone numbers, a database of basic customer account information for all or a portion of the customers/subscribers of the communication service provider network 150, a cellular network service home location register (HLR), e.g., with current serving base station information of various subscribers, and so forth, a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other network components 155 may include, for example, a layer 3 router, a short message service (SMS) server, a voicemail server, a video-on-demand server, a server for network traffic analysis, a database server/database system, and so forth. It should be noted that in one example, a communication network component may be hosted on a single server, while in another example, a communication network component may be hosted on multiple servers, e.g., in a distributed manner.

In accordance with the present disclosure, network components 155 may comprise “network resources” of various network resource types, which may also include services provided and/or hosted via network components 155, e.g., enterprise communication services, such as a virtual private network (VPN) service, a virtual local area network (VLAN) service, a Voice over Internet Protocol (VoIP), a software defined-wide area network (SD-WAN) service, an Ethernet wide area network E-WAN service, and so forth. Alternatively, or in addition, network resources may include interfaces or ports associated with such services, such as a customer edge (CE) router or PBX-to-time division multiplexing (TDM) gateway interface, a Border Gateway Protocol (BGP) interface (e.g., between BGP peers), and so forth. For instance, a CE router, PBX, or the like may be homed to one or several provider edge (PE) routers or other edge component(s).

In one example, the data center network 130 may comprise a local area network (LAN), or a distributed network connected through permanent virtual circuits (PVCs), virtual private networks (VPNs), and the like for providing data and voice communications. In one example, the data center network 130 may comprise one or more devices for providing services to subscribers, customers, and/or users. For example, communication service provider network 101 may provide a cloud storage service, web server hosting, and other services. As such, data center network 130 may represent aspects of communication service provider network 101 where infrastructure for supporting such services may be deployed. In one example, the data center network 130 may alternatively or additionally comprise one or more devices supporting operations and management of communication service provider network 101. For instance, in the example of FIG. 1, server(s) 139 may include higher level services/applications such as a database of assigned telephone numbers, a database of basic customer account information for all or a portion of the customers/subscribers of the communication service provider network 101, a billing system, a customer relationship management (CRM) system, a trouble ticket system, an ordering system, an enterprise reporting system (ERS), an account object (AO) database system, a network inventory system, a network topology/mapping system, a network provisioning system, a unified data repository (UDR), and so forth. In one example, server(s) 139 may alternatively or additionally comprise one or more of the types of network components 155 described above.

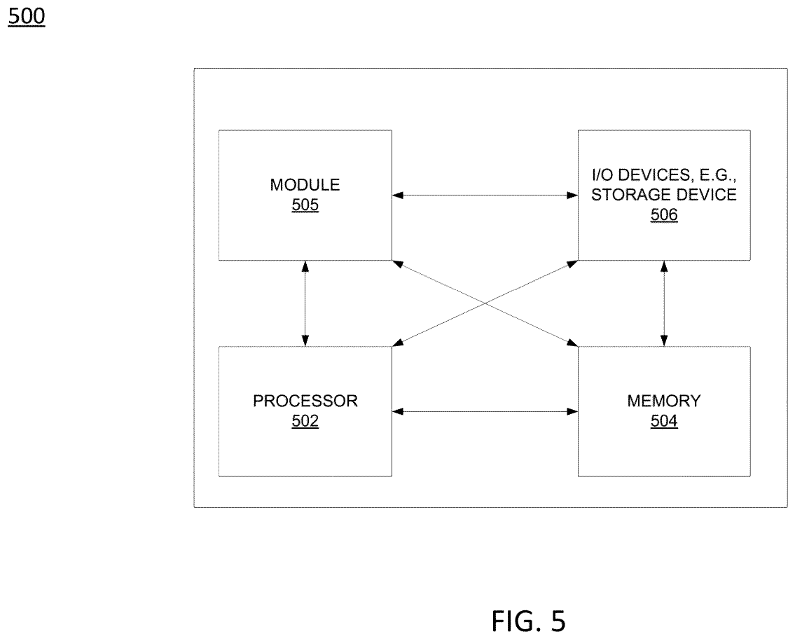

In addition, data center network 130 may include one or more servers 135 which may each comprise all or a portion of a computing device or system, such as computing system 500, and/or processing system 502 as described in connection with FIG. 5 below, specifically configured to perform various steps, functions, and/or operations for generating a network topology visualization from a query result obtained via applying a query generated via a generative model from a prompt in accordance with a natural language request, as described herein. For example, one of the server(s) 135, or a plurality of the servers 135 collectively, may perform operations in connection with the example method 400, or as otherwise described herein.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

In one example, data center network 130 may also include one or more databases (DBs) 136, e.g., physical storage devices integrated with server(s) 135 (e.g., database servers), attached or coupled to the server(s) 135, and/or in remote communication with server(s) 135 to store various types of information in connection with examples of the present disclosure. For example, DB(s) 136 may be configured to receive and store network topology data, including the type(s) of network resources/network elements (e.g., both physical and virtual), the locations of such network resources, the connectivity between resources, the allocation of such resources to sub-nets, tracking areas, or the like, and so forth. In one example, the network topology information/data may include or may be cross-referenced to network inventory data, such as, for physical network resources, the manufacture date, the purchase date, the deployment date, the last serviced date and/or a service history, identities of the service technician(s), an incident/event list (e.g., for past network events associated with the network resource), a serial number, a model number, a version number, a software version, and so forth. In one example, the network topology data may comprise a network graph, or network graph database. For instance, nodes in the graph/graph database may represent network resources, network zones, etc., where some links/edges may represent physical links, or logical paths over physical links, while other links/edges may represent logical relationships, such as a virtual network function (VNF) being instantiated on a particular network function virtualization infrastructure (NFVI) physical element, a network resource being a component of a particular sub-net or tracking area, etc.

In addition, DB(s) 136 may be configured to receive and store network operational data, including performance indicator data (e.g., “key performance indicators” (KPIs)), such as: utilization and/or availability levels of network resources, configuration settings and/or parameters of such network resources, alarm data, and so forth. For instance, such data may be collected from various network components 155 reporting to server(s) 135 and/or to DB(s) 136, such as routers, RAN elements, cellular core network components, video distribution components, storage servers, content distribution network nodes, etc. In this regard, it should be noted that in one example, network component(s) 115 may also include one or more aggregator devices for collecting performance data (e.g., KPIs) and/or configuration data for various network elements and/or aspects of communication service provider network 101. For instance, such aggregator device(s) may collect performance indicators and/or configuration data over a period of time, and may then provide a batch report and/or aggregated records to DB(s) 136, for instance. It should be noted that some or all of such information (network topology and/or network operational) may be contained in other network databases/systems, such as one or more of an active and available inventory (A&AI) database, a network inventory database, a call detail records (CDR) repository, or the like (e.g., represented by server(s) 139 and/or various network components 155). Alternatively, or in addition, DB(s) 136 may be configured to receive and store customer/subscriber network resource order information (e.g., an additional type or types of network operational data), such as the subscriber/customer identities and other characteristics (e.g., a customer intensity value and/or a customer segment as described herein), the timing of such orders, the quantities of such orders, the type of service(s) ordered, and so forth. In one example, aspects of the abovementioned data may be stored in user, subscriber, and/or account profiles, which may include account owner biographic information, such as individual or entity name, address, phone number(s), device identifier(s), authorized users, age(s), service history, payment history, payment methods, communication preferences, privacy preferences, and so forth. In other words, some of the abovementioned data types may be stored in or linked to respective user/account profiles, or the like. Similar to the above, some or all of such information may be contained in other network databases/systems, such as one or more of an authentication, authorization, and accounting (AAA) server/system, an operations support system (OSS), a business support system (BSS), a unified data repository (UDR), or the like.

It should be noted that in accordance with the present disclosure, the network topology information/data and/or network operational data stored in DB(s) 136 or elsewhere may be maintained over a period of time. For instance, DB(s) 136 may store respective time series data indicative of different states of a network topology, different utilization and/or assignment levels of various network resources of various types in a given time interval (and over a period of a plurality of time intervals), etc. In one example, data may be segregated by customer segment, network zone, geographic region, and so forth.

In one example, DB(s) 136 may alternatively or additionally receive and store data from one or more external data feeds. For instance, DB(s) 136 may receive and store geographic data, e.g., from one or more external services, such as a geographic information system (GIS), which may include digital map data such as geo-political boundary maps, terrain maps, and so forth. Alternatively, or in addition, DB(s) 136 may receive and store weather data from a device of a third-party, e.g., a weather service, a traffic management service, etc. via one of the access/service networks 110 or 120. To illustrate, one of endpoint devices 111-113 or 121-123 may represent a weather data server (WDS). In one example, the weather data may be received via a weather service data feed, e.g., an NWS extensible markup language (XML) data feed, or the like. In another example, the weather data may be obtained by retrieving the weather data from the WDS. In one example, DB(s) 136 may receive and store weather data from multiple third-parties, which can then be correlated to network traffic data to reflect impact of various weather conditions on overall network traffic. In still another example, one of the endpoint devices 111-113 or 121-123 may represent a server of a traffic management service (e.g., for vehicular traffic) and may forward various traffic related data to DB(s) 136, such as toll payment data, records of traffic volume estimates, traffic signal timing information, and so forth. Similarly, one of the endpoint devices 111-113 or 121-123 may represent a server of an entertainment event notification service (e.g., a Really Simple Syndication (RSS) feed or the like). In such an example, DB(s) 136 may obtain one or more data sets/data feeds comprising information such as: notifications of mass sporting events, concerts, parades, civic gatherings, etc., including location information, time and duration information, expected attendance, and so forth.

In one example, DB(s) 136 may also store artificial intelligence (AI) models and/or machine learning models (MLMs) that may be trained by, activated, and/or deployed by server(s) 135 in connection with examples of the present disclosure. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In one example, the one or more of the servers 135 and/or server(s) 135 in conjunction with DB(s) 136 may comprise a generative MLM-based communication network knowledge platform (e.g., a network-based and/or cloud-based service hosted on the hardware of server(s) 135 and/or DB(s) 136).

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a generative adversarial network (GAN), a decision tree algorithm/model, such as gradient boosted decision tree (GBDT) (e.g., XGBoost, XGBR, or the like). In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data. In one example, MLMs of the present disclosure may include an ML-based generative model, such as a language model, e.g., a “large language model” (LLM). For instance, an ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. In one example, MLMs of the present disclosure may comprise an ada text embedding model.

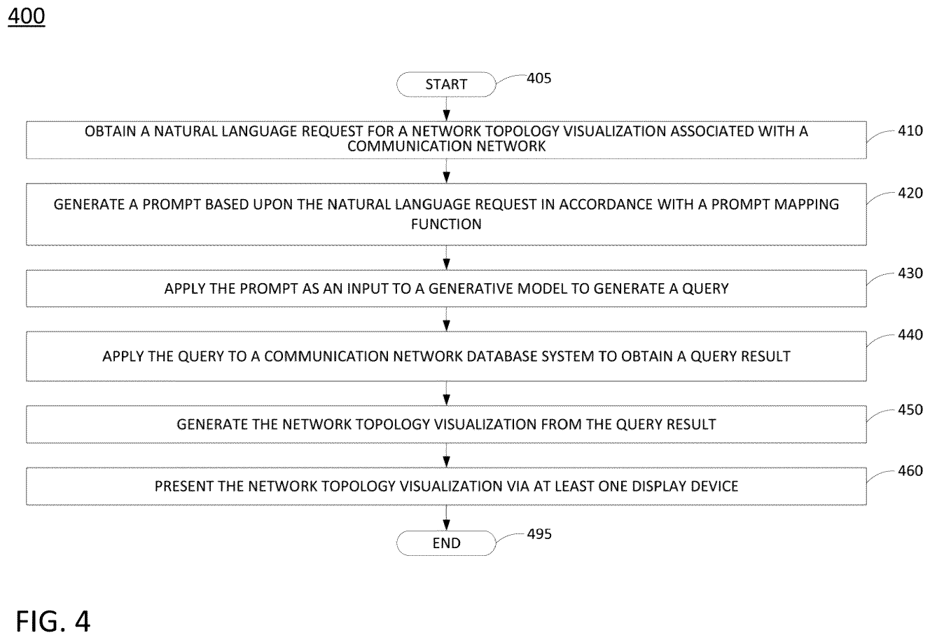

As noted above, server(s) 135 may be configured to perform various steps, functions, and/or operations for generating a network topology visualization from a query result obtained via applying a query generated via a generative model from a prompt in accordance with a natural language request, as described herein. For instance, an example method for generating a network topology visualization from a query result obtained via applying a query generated via a generative model from a prompt in accordance with a natural language request is illustrated in FIG. 4 and described in greater detail below. To further illustrate, server(s) 135 may obtain a natural language request for a network topology visualization associated with a communication network. For example, server(s) 135 may comprise a generative MLM-based communication network knowledge platform that may be used by network personnel for network operations and management, network troubleshooting and maintenance, network planning, and other tasks that may involve network topology visualization. As such, server(s) 135 may obtain network topology data that may be stored in DB(s) 136 or elsewhere. In one example, server(s) 135 may also retrieve network operational data (such as network performance indicator data, configurable setting values for one or more network settings e.g., KPIs or other measurements self-reported by devices or measured by other entities within the network, customer/subscriber account data, and so forth), or external data, such as weather data, entertainment or other event data, etc. Server(s) 135 may next generate a prompt based upon the natural language request in accordance with a prompt mapping function, as described in greater detail below. Server(s) 135 may further apply the prompt as an input to a generative model, e.g., implemented by server(s) 135, to generate at least one query. Server(s) 135 may then apply the at least one query to a communication network database system (e.g., represented by at least a portion of DB(s) 136, network component(s) 155, etc.) to obtain a query result. For instance, the query result may comprise at least a portion of the network topology data that may pertain to the natural language request. In some examples, the query result may also include relevant aspects of network operational data or other data (such as weather data, etc.).

Server(s) 135 may next generate the network topology visualization from the query result. For instance, this may include server(s) 135 mapping at least a portion of the natural language request to a particular network topology visualization type among a plurality of available types of network topology visualizations. In one example, this may also include server(s) 135 mapping at least a portion of the natural language request to a scope of the particular network topology visualization type (e.g., showing one hop, two hops, etc. from a network component and/or location of a network event, from one or more root cause(s), event(s), and/or network condition(s), including or omitting geographic element(s)/layer(s), and so forth).

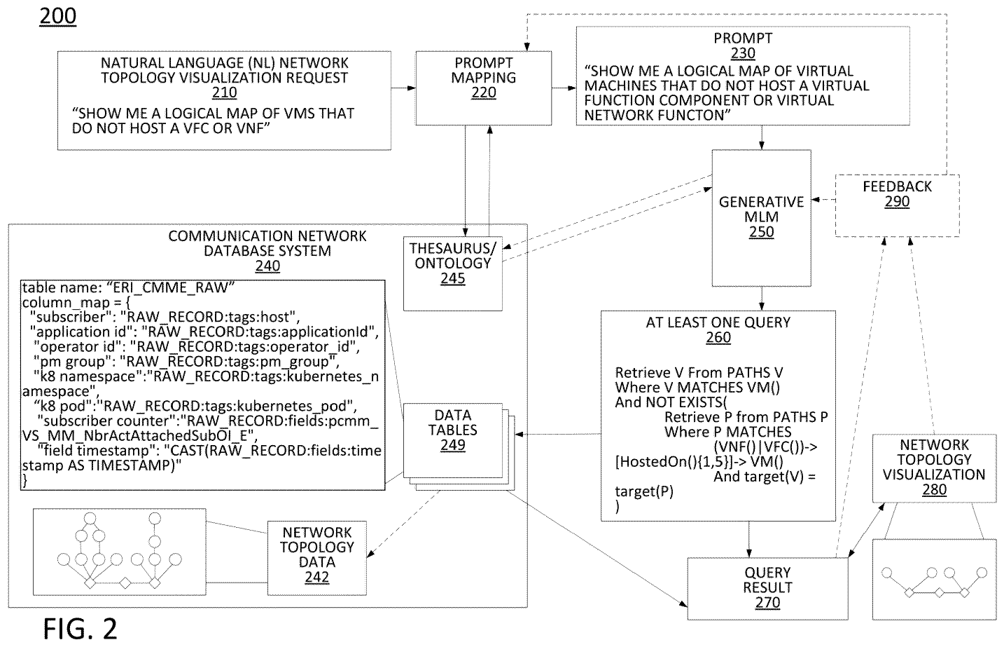

In one example, generating of the network topology visualization may include server(s) 135 implementing a second generative MLM for generating instructions in accordance with a network topology visualization tool/platform (or server(s) 135 implementing the same generative MLM that is tuned for generating instructions to a visualization tool via prompt enhancement and RAG). For instance, server(s) 135, via a generative MLM, may generate instructions to a visualization tool, which may have a catalog of available network topology visualization types, and configurable parameters for each, e.g., zoom level, number of hops, include or omit geographic element/layer, and so forth. Lastly, server(s) 135 may present the network topology visualization, e.g., via at least one display device, such as a network personnel device 134, e.g., a personal computing device such as a desktop computer, laptop computer, tablet computing device, etc., or via a printout via a printer, and so forth. Servers(s) 135 may alternatively or additionally perform various operations as described in connection with FIGS. 2-5, or elsewhere herein.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of the server(s) 135 and DB(s) 136 may be distributed at different locations, such as in or connected to access/service networks 110 and 120, in another service network connected to Internet 160 (e.g., a cloud computing provider), in core/backbone network 150, and so forth. Thus, these and other modifications are all contemplated within the scope of the present disclosure.

FIG. 2 illustrates an example process 200 for generating a network topology visualization from a query result obtained via applying a query generated via a generative model from a prompt in accordance with a natural language request, in accordance with the present disclosure. In particular, the process 200 may be implemented by a generative MLM-based communication network knowledge platform, such as server(s) 135 of FIG. 1, or the like. As illustrated in FIG. 2, the process 200 may begin with a natural language (NL) network topology visualization request 210. For instance, an example, NL network topology visualization request may be: “show me a logical map of VMs that do not host a VFC or VNF.” Other example requests may be: “show me a map of RAN physical components for TAI ABC12345 with terrain overlay,” “for each PDU session establishment failure within the last 10 minutes associated with cell XYZ98765 show me a logical map of all network resources within two hops of any network resource identified as a root cause,” “show me a physical map of all links in network zone NE experiencing an overload condition between 1:00 PM and 2:00 PM, Tuesday,” “show me a physical map highlighting all links in network zone NE experiencing an overload condition between 1:00 PM and 2:00 PM, Tuesday with street map,” and so forth. It should be noted that NL network topology visualization request 210 may also be considered or referred to as a “prompt.” However, to disambiguate from other aspects of the present disclosure, the term “request” may primarily be used to refer to a user's NL input requesting network topology visualization, e.g., with respect to network topology data from communication network database system 240.

Communication network database system 240 may comprise a data warehouse that stores data in different formats, such, as comma separated values, JSON, relational databases, graph databases, and so forth. In the present example, communication network database system 240 may include network topology data 242. In one example, the network topology data 242 may comprise or be stored in a graph, or graph database format (e.g., a network graph or network topology graph). For instance, nodes in the graph/graph database may represent network resources, network zones, etc., and where some links/edges may represent physical links or logical paths over physical links, while other links/edges may represent logical relationships, such as a virtual network function (VNF) being instantiated on a particular network function virtualization infrastructure (NFVI) physical element, a network resource being a component of a particular sub-net or tracking area, and so on. For instance, interconnected links and devices may be indicated by such a graph database. In addition, circuits, label switched routes (LSRs), customer VPNs and so forth which are dependent upon links, and devices which may be associated with a network disruption may also be indicated in such a graph database. Alternatively, or in addition, the network topology data 242 may comprise or be stored in a relational database format, e.g., table data format. For instance, network topology data 242 may include one or more tables in which rows may represent network components, and where each row may include various information about a network element, including the connections to other network elements, e.g., physical or logical links, the ports, interfaces, or the like, connecting a particular network element to one or more other network elements, and so forth. In one example, a row may reference other rows, e.g., other network resources to which a given network resource may have a physical or logical connection.

In one example, communication network database system 240 may also include a plurality of data tables 249, e.g., storing network operational data such as described above. For instance, the network operational data may include network troubleshooting data, configuration settings/parameters of various devices, systems, services, or the like, in a communication network, optimization and workflow data, customer/subscriber data, etc. It should be noted that the present examples of network operational data are provided by way of illustration only. Thus, it should be appreciated that examples of the present disclosure are not limited to any particular type of network operational data or sub-categorizations of such network operational data. In one example, the communication network database system 240 may include a thesaurus/ontology 245, as described in greater detail below.

As noted above, examples of the present disclosure may automatically generate and run queries based upon NL network topology visualization requests. In one example, and as illustrated in the example process 200 of FIG. 2, the generative MLM-based communication network knowledge platform may perform a prompt mapping 220 to create a prompt 230 to be used as an input/prompt for a generative model 250, e.g., a generative machine learning model (MLM). In particular, the prompt 230 may be particularized, e.g., optimized with respect to the communication network database system 240 and/or a knowledge base associated with communication network management and/or communication network operations, or the like. To illustrate, the prompt mapping 220 may include natural language processing (NLP) to map terms in the natural language request (e.g., more general/colloquial term) to terms that are optimized for a prompt input to a generative model in a subsequent phase (e.g., more technical terms for the same “concepts” and/or terms that are particularized to the terminology used in the communication network database system 240).

For instance, in one example, the prompt mapping 220 may utilize a mapping table maintained by the generative MLM-based communication network knowledge platform in which technical terms, or terms that are used to define node or link types in a network topology graph database and/or table columns or fields of data tables 294 of the communication network database system 240, are mapped to corresponding informal terms. For instance, a column in one of the data tables 249 may be labeled as “host.” However, the term “subscriber” may be more typically used by most users to refer to the same concept. Accordingly, the mapping table may include a list of entries that associate these more commonly used words to the corresponding more technical terms. In one example, the mapping may be particularized for handling JSON data. For instance, each entry in a JSON column of a data table 249 may include multiple fields. In some case, the number of fields may be in the hundreds or more, for example. The mapping table may therefore associate table column labels and/or the JSON field labels within corresponding informal terms.

In one example, the mapping table may be generated using domain knowledge, e.g., where an expert may map common words to more technical words that may be associated with graph nodes, graph links, table columns, JSON fields, or the like. In one example, the generative MLM-based communication network knowledge platform may automatically adapt the mapping table to handle new data, e.g., new node types (e.g., new network resource/network element types), new link types (e.g., new interface or port types, etc.), new tables and/or columns, and so forth. For instance, the mapping table may start with data tables 249 having columns and/or fields that are mapped with certain terms. Then as time progresses, new tables may be added to data tables 249 with new columns and/or fields that may be similar to other fields in one or more others of the data tables 249. As such, the generative MLM-based communication network knowledge platform may adapt the mapping to the new tables and the columns and/or fields therein. For instance, as new tables are added to data tables 249, network personnel may indicate certain fields in the new tables that may be the same as others in existing ones of the data tables 249. Thus, even if different column and/or field labels are used, the mapping table may still map more informal terms used in natural language with the corresponding technical and/or domain-specific terms that may be used as column and/or field labels. Similarly, the mapping table may start with nodes and links (and/or node types and link types) in a network topology graph that are mapped with certain terms. Then as time progresses, users and/or other automated systems may attempt to add new nodes and links, or new node types and link types to the network topology graph that may be similar to one or more others that are already existing. As such, the generative MLM-based communication network knowledge platform may adapt the mapping to the new nodes, link, node types, and/or link types.

In one example, the generative MLM-based communication network knowledge platform may perform the prompt mapping 220 using a thesaurus/controlled vocabulary, or an ontology (e.g., thesaurus/ontology 245 of the communication network database system 240). For instance, the thesaurus/ontology 245 may comprise a feature graph database or “feature graph.” For instance, the feature graph database may comprise an “ontology graph” that represents both lineage and nomenclature for “features” of the communication network database system 240 (e.g., nodes, links, tables, columns, and/or fields). For example, nodes (in the ontology graph) may represent column and/or field labels in data tables 249. Edges/links (in the ontology graph) may represent table columns/fields that are the same or related, e.g., “is a subset of,” “is derived from,” etc. In one example, such an ontology graph may further include nodes for “natural language terms” and links/edges to other nodes representing the corresponding “technical terms,” e.g., the actual field and/or column labels. Alternatively, or in addition, nodes (in the ontology graph) may represent node types and/or link types in a network topology graph represented by network topology data 242. In one example, the thesaurus/ontology 245 may represent synonyms and/or antonyms in a knowledge graph, e.g., without additional domain knowledge embedded in the edges and other nodes, for example. In this regard, a thesaurus may be considered a subset, or sub-graph of an ontological graph as described above. In one example, the generative MLM-based communication network knowledge platform may maintain the thesaurus/ontology 245 via machine learning feedback as described in greater detail below.

In any case, the generative MLM-based communication network knowledge platform may utilize the mapping table and/or the thesaurus/ontology 245 (more generally or collectively referred to a mapping function) to revise the NL request 210 into a prompt 230 having a format that is more likely to solicit an optimized result from a generative MLM. For instance, in the example of FIG. 2, the NL network topology visualization request 210 may be: “show me a logical map of VMs that do not host a VFC or VNF.” In one example, the automatically generated prompt 230 may then be “show me a logical map of virtual network functions that do not host a virtual function component or virtual network function”. In other examples, the automatically generated prompt 230 may truncate the NL request 210 to exclude portions relating to network topology visualization type or settings, e.g., excluding “show me a logical map . . . ” In one example, the automatically generated prompt 230 may include a requested action. For instance, in accordance with the present disclosure, all NL network topology visualization requests may assume that at least some data may be retrieved from communication network database system 240. As such, the prompt 240 may include a default action being requested, such as “extract” or “obtain.” For example, this may prepend to the result in “retrieve virtual network functions that do not host a virtual function component or virtual network function,” or the like, whereas in the first example, the action may be implied or understood, e.g., as a result of training of the generative MLM 250 for its specific purpose of generating queries to be applied to the communication network database system 240.

Next, the automatically generated prompt 230 may be applied as an input/prompt to the generative MLM 250. The generative MLM 250 may comprise, for example, a large language model (LLM). For instance, the generative MLM 250 may comprise a generative pre-trained transformer (GPT) model, a Large Language Model Meta AI (LLaMA) model, a Language Model for Dialogue Applications (LaMDA) model, a Pathways Language Model (PaLM) model, a bidirectional transformer that is pre-trained for language understanding/natural language processing (NLP) tasks (e.g., a Bidirectional Encoder Representations from Transformers (BERT) model), and so forth. In one example, the generative MLM 250 may include a mixture of experts or ensemble of multiple base MLMs.

In one example, different MLMs may be possessed by the generative MLM-based communication network knowledge platform, where based on the accuracy/quality of the response/output, these MLMs can be reconfigured/retrained in an adaptive way. As such, in one example, the generative MLM 250 may comprise one or more MLMs that are selected via an auto-ML process. For instance, an operator may provide one or more optimization criteria to obtain the best performing model with respect to accuracy, speed, a combination of such factors, etc. In addition, in one example, the generative MLM 250 may be adapted from a pre-trained model, where the framework of the generative MLM-based communication network knowledge platform may be used to modify and retune the adopted model(s), e.g., specifically to generate queries for the communication network database system 240, and in one example, more specifically including the network topology data 242. Thus, it should be noted that training of the generative MLM 250 can be accomplished in different ways such as training from scratch, fine-tuning of a pre-trained model, retrieval-augmented generation (RAG), reinforcement learning using feedback, prompting/prompt-tuning, learning using adapters, a combination of any of the foregoing, and so forth.

In one example, in accordance with the present disclosure, a retrieval augmented generation (RAG) process may be implemented when inputting the prompt 230 to the generative MLM 250. For instance, domain knowledge may be embedded in the prompt 230 or provided along with the prompt 230. For instance, this may comprise vectorized table column and/or field labels of the data tables 240 (including network topology data 242) and/or the thesaurus/ontology 245. In one example, a selection from the thesaurus/ontology 245 may be used, e.g., a sub-graph associated with one or more nodes representing one or more mapped terms, e.g., along with edges and one-hop associated nodes, two-hop associated nodes, etc. Notably, this supplemental prompt input data may bias the generative MLM 250 to be more likely to generate a focused query, e.g., which is more likely to result in the retrieval of the relevant/correct subset(s) of network topology data 242 and/or other data from data tables 249 as the query result 270. In one example, a portion of the prompt 230 relating to the type of network topology visualization and any customizations thereof may be truncated from the prompt 230 before submission as input to the generative MLM 250 (e.g., the portion of the prompt 230 “Show me a logical map of . . . ”). In one example, each prompt, such as prompt 230, input to the generative MLM 250 may be preceded by standardized prompt content and/or may be inserted into a prompt template, such as “generate a query for the request: ______.” For instance, in the example illustrated in FIG. 2, the blank may be filled with “retrieve virtual network functions that do not host a virtual function component or virtual network function.”

The generative MLM 250 may generate at least one query 260 in response to the prompt 230 as input (and in one example, along with supplemental input(s), such as RAG content, as described above). For instance, in response to the prompt 230 “retrieve virtual network functions that do not host a virtual function component or virtual network function” and/or “generate an query for the request: ‘virtual network functions that do not host a virtual function component or virtual network function’”, the generative MLM 250 may generate the at least one query 260 as illustrated in FIG. 2. In this regard, it should be noted that in one example, the generative MLM 250 may be trained and deployed to generate a graph database query (e.g., in accordance with a syntax of a graph query language, such as GraphQL, Gremlin, Cypher (Neo4j), etc.). In one example, the generative MLM 250 may generate more than one query. For instance, some NL network topology visualization requests may involve the retrieval of network topology data 242 (e.g., in graph database format) as well as other network operational data (e.g., which may be stored in data tables 249 in an SQL-accessible format). Thus, for example, the generative MLM may generate two queries to retrieve the relevant data via respective query language syntaxes from the respective data sources in the communication network database system 240. However, in another example, the at least one query 260 may comprise a single query that may retrieve the relevant portions of data in graph database format and SQL-accessible format, respectively. For example, some SQL databases/database system may include the capability to represent graphs/graph database, and may further include extensions in SQL syntax and/or additional available commands, operators, or the like that are specific to data having graph-based relationships, such as network topology data, etc.

Next, the at least one query 260 may be applied to the communication network database system 240 (e.g., to network topology data 242 and/or others of data tables 249 thereof), to obtain the query result 270. For instance, the query result 270 may comprise a sub-graph of a network topology graph and/or a result table, e.g., containing data extracted from network topology data 242 and/or others of data tables 249, and in some case combined or otherwise modified via operations, such as union, join, merge, etc.

Lastly, the generative MLM-based communication network knowledge platform may generate a network topology visualization 280 based upon the query result 270. For instance, in the example of FIG. 2, network topology visualization 280 may include a logical map that illustrates VMs that do not host VFCs or VNFs. In the present example, the logical map may also include the identification of underlying hardware, e.g., NFVI/hosts. For instance, the VMs may be represented by the circles and the NFVI/hosts may be represented by the diamonds (with links between the hosts also illustrated). In various other examples, network topology visualizations may include a geographic map identifying a location of a root cause router(s), a logical map indicating the root cause router(s) in the context of the various links to other routers or other network components, a virtual private network (VPN) topology map, a network route impairment map showing a route between two endpoints that is impaired (or several routes that may be impaired), etc. In one example, additional visual indicators such as coloring, shading, highlighting, varying intensity, or the like, may be utilized to indicate a severity of a soft failure. For instance, the more customer routes affected and/or a greater volume of customer traffic affected may result in a higher severity indicator.

In one example, generating of the network topology visualization 280 may include generative MLM-based communication network knowledge platform implementing a second generative MLM for generating visualization tool/platform instructions (or generative MLM-based communication network knowledge platform implementing the same generative MLM for generating the at least one query 260, but now tuned for generating instructions to a visualization tool via prompt enhancement and RAG). For instance, generative MLM-based communication network knowledge platform, via a generative MLM, may generate instructions for a visualization tool which may have a catalog of available network topology visualization types, and configurable parameters for each, such as a selectable zoom level, a selectable number of hops from one or more network resources to include in the visualization, an option to include or omit geographic element(s)/layer(s), road map element(s)/layer(s), and so forth. Thus, the generative MLM-based communication network knowledge platform, via the generative MLM, may infer intents from the NL query and may output visualization generation instructions to the network topology visualization tool/platform in accordance with the intents. In one example, RAG at this phase can include feeding additional inputs to the generative MLM such as an instruction manual for the network topology visualization tool/platform, API information, examples of instruction syntax, or the like. In one example, the RAG content may also include examples of natural language requests and intents. For instance, a network operator may generate positive examples (and/or negative examples) of NL requests for each available type of network topology visualization supported by the tool/platform, or the like.

In various examples, the network topology visualization 280 may be presented via a display screen of a user's computing device, as a print-out via a printer, and so forth. In one example, the generative MLM-based communication network knowledge platform may include a component for generating network topology visualizations. In another example, generative MLM-based communication network knowledge platform may instruct (e.g., via an application programming interface (API) or the like) another platform, application, program, or the like that generates network topology visualizations from input data, such as the query result 270 in result table format. It should also be noted that a graph database, such as represented by network topology data 242, may comprise a “master” network topology database with all physical network resources (including physical links (i.e., optical cables, coaxial cables, etc.) and all logical resources, including virtual network functions, logical links, etc., where network topology visualizations may be generated from less than an entirety of such a network topology database. Thus, for example, FIG. 2 illustrates a conceptualization of a graph data structure representing the network topology (e.g., in connection with network topology data 242), whereas the network topology visualization 280 may comprise an actual image rendered on a screen, or the like, which includes a visual representation of a relevant portion of the network topology data 242 as stored in the communication network database system 240.

To improve the accuracy and/or other performance aspects of the generative MLM-based communication network knowledge platform, in one example feedback 290 (e.g., from a user or other automated systems) may be applied to the generative MLM 250. For instance, a user may submit the NL network topology visualization request 210. The generative MLM-based communication network knowledge platform may then retrieve the query result 270, and provide the output (e.g., network topology visualization 280) to the user. In one example, a user may provide feedback 290, e.g., comprising an indication that the network topology visualization 280 is correct, incorrect, sufficient, insufficient, etc. For instance, the feedback can indicate that the rendering of the visualization is not in accordance with the user's intent and/or may indicate that the data from which the network topology visualization 280 is rendered does not appear to be correct (for example it may include network components that clearly did not meet geographic criteria, a component type criteria, or the like that was set forth in the request 210). The latter type of feedback may indicate a problem with the formulation of the at least one query 260, for example.

The generative MLM-based communication network knowledge platform may then utilize the feedback 290, e.g., as labels to retrain the generative MLM 250 (or a second generative MLM that may be used at the network topology visualization generating stage). Alternatively, or in addition, the generative MLM-based communication network knowledge platform may utilize feedback 290 to update the mapping function (e.g., a mapping table and/or thesaurus/ontology 245) over time to determine which NL terms should be mapped to which other terms that should be used in generating the mapped prompt 230.

In addition, it should be realized that the process 200 may be implemented in a different form than that illustrated in FIG. 2, or may be expanded or modified by including additional or different stages/operations, omitting stages/operations, etc. Similarly, in other examples, the process 200 may include other types of data, e.g., extracting weather data, retail data, vehicular traffic data, medical data, epidemiological data, and so on, which may be added as overlay layer(s), which may be used as filter criteria for obtaining aspects of network topology data 242 or other network operational data, e.g., from data tables 249, and so forth. Furthermore, although examples of the present disclosure are described primarily in connection with a graph database and/or an SQL database, other examples of the present disclosure may include other query languages that relate to structured and/or unstructured data sets, such as Pipelined Relational Query Language (PRQL), and so forth. Thus, these and other modifications are all contemplated within the scope of the present disclosure.

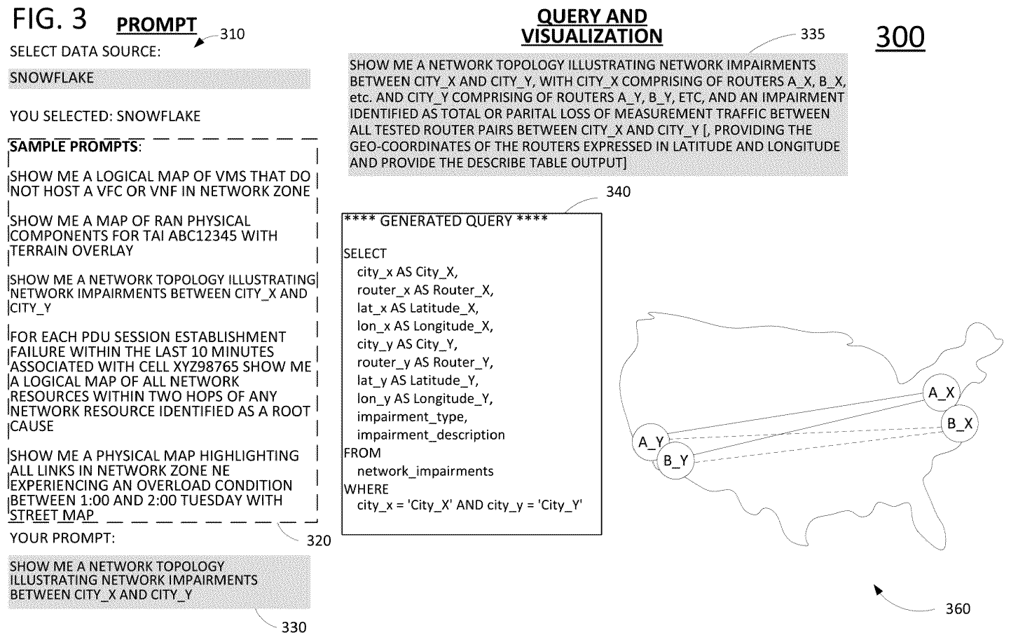

FIG. 3 illustrates an example user interface (UI) 300, e.g., a graphical user interface (GUI) for automated network topology visualization in accordance with the present disclosure. For instance, as shown in FIG. 3, the example UI 300 may include a field 310 to select a data source. For instance, in the present example, the data source of “Snowflake” may be selected. In various examples, field 310 may comprise a fillable field, a drop-down menu, and so forth. In one example, the UI 300 may present sample prompts, e.g., in region/box 320. For instance, the sample prompts may be provided by a system designer and may appear in response to the selection of the data source. For instance, different sample prompts may be presented to the user for different selected data sources. Alternatively, or in addition, different sample prompts may be suggested to different users, e.g., based upon the user's past requests/prompts, based upon the user's identity or role, e.g., within an organizational structure for communication network operations personnel, and so forth. In the present example, the UI 300 further includes a box/field 330 for the user's current prompt/request, e.g., “your prompt:” indicates that the user has provided the following prompt: “SHOW ME A NETWORK TOPOLOGY ILLUSTRATING NETWORK IMPAIRMENTS BETWEEN CITY_X AND CITY_Y”. In this case, city X and city Y are used as illustrative examples. Thus, it should be understood that in practice, a user may insert actual place names instead of “city X” and “city Y”, such as “New York” and “Los Angeles”, etc.

The UI 300 may further include a box/region 335 to present a generated prompt that is used as input to a generative AI/ML model to generate a query as an output. In this regard, the example UI 300 includes box/region 340 to present the query generated based upon the enhanced prompt/request of box/region 335. Below this box/region 340 may be an output network topology visualization 360, e.g., in this case a map of routers in cities X and Y with the paths between routers, where solid links may indicate paths with total loss/impairment, and where dotted lines may indicate paths with partial loss/impairment. It should be noted that the example network topology visualization 360 may include a geographic layer/element, or geographic overlay, e.g., a map of the United States, including cities X and Y. In one example, the geographic overlay may be included in the network topology visualization 360 based upon a configuration of a network topology visualization tool/platform. For instance, as discussed above, a generative MLM-based communication network knowledge platform of the present disclosure may generate instructions (e.g., via a generative MLM) for a visualization tool, which may have a catalog of available network topology visualization types, and configurable parameters for each, such as a selectable zoom level, a selectable number of hops from one or more network resources to include in the visualization, an option to include or omit geographic element(s)/layer(s), road map element(s)/layer(s), and so forth. In one example, some of these parameters may be selected via the generative MLM and included in the output instructions based upon an indication in the request (e.g., “ . . . with geographic overlay,” etc.). For example, the user prompt in 330 may alternatively be “SHOW ME A NETWORK TOPOLOGY ILLUSTRATING NETWORK IMPAIRMENTS BETWEEN CITY_X AND CITY_Y WITH GEOGRAPHIC OVERLAY”. In this regard, the example generated prompt in box 335 may include the appended aspect to the request: “PROVIDING THE GEO-COORDINATES OF THE ROUTERS EXPRESSED IN LATITUDE AND LONGITUDE AND PROVIDE THE DESCRIBE TABLE OUTPUT”. For example, the may help to ensure that the generated query of box 334 (e.g., the output of generative AI/ML model for query generation) is tailored to gather the relevant geographic coordinate data of the respective routers.

To further illustrate, an example of a result table may include lines/entries such as follows: (‘City_X’, ‘Router_A_X’, 40, −74, ‘City_Y’, ‘Router_A_Y’, 34, −118, ‘Total Loss’, ‘Complete loss of measurement traffic between Router_A_X and Router_A_Y’); (‘City_X’, ‘Router_B_X’, 40, −73, ‘City_Y’, ‘Router_B_Y’, 34, −118, ‘Partial Loss’, ‘Partial loss of measurement traffic between Router_B_X and Router_B_Y’); (‘City_X’, ‘Router_A_X’, 40, −74, ‘City_Y’, ‘Router_B_Y’, 34, −118, ‘Total Loss’, ‘Complete loss of measurement traffic between Router_A_X and Router_B_Y’); (‘City_X’, ‘Router_B_X’, 40, −73, ‘City_Y’, ‘Router_A_Y’, 34, −118, ‘Partial Loss’, ‘Partial loss of measurement traffic between Router_B_X and Router_A_Y’). It should again be noted that this example is illustrative in nature and that actual geographic coordinates may be more precise, the actual city/place names may be included instead of cities X and Y, etc.

Alternatively, or in addition, some of network topology visualization settings/parameters may be selected via the generative MLM based upon an identity of a user initiating the request/prompt 330, a role of the user, etc. For instance, the generative MLM may learn user preferences for certain types of network topology visualization options/settings, or may be biased with user preference via RAG, supplemental prompt content, or the like. Alternatively, or in addition, some settings/parameters may be set by default and may remain in effect unless changed. For example, an impairment map may default to include a geographic overlay map, but this may be changed via an explicit instruction in the query of box 330 to exclude, or the like.

In this regard, it should also be noted that FIG. 3 illustrates just one example of a user interface 300 in accordance with the present disclosure. As such, other, further, and different example user interfaces of the present disclosure may have a different form and may include, more, less, or different features form the UI 300. For instance, the query box/region 340 may be omitted, the network topology visualization 360 area may include buttons, menus, etc., which may enable a user to modify the network topology visualization 360, such as to add/remove a geographic map element/layer, to add additional links, hops, or the like, e.g., along the respective paths between routers A_X, B_X, A_Y, and B_Y, to zoom in, to zoom out, and so forth. Similarly, the network topology visualization 360 may be interactive such that clicking on one of the routers A_X, B_X, A_Y, or B_Y may provide additional information about the network resource, such as current or last collected utilization/load metrics (e.g., KPIs), and so forth, e.g., where additional information may be presented in a pop-up window, on a different screen, and so forth. Thus, these and other modifications are all contemplated within the scope of the present disclosure.

FIG. 4 illustrates a flowchart of an example method 400 for generating a network topology visualization from a query result obtained via applying a query generated via a generative model from a prompt in accordance with a natural language request. In one example, steps, functions, and/or operations of the method 400 may be performed by a device as illustrated in FIG. 1, e.g., one or more of the servers 135, or the like, such as generative MLM-based communication network knowledge platform. Alternatively, or in addition, the steps, functions and/or operations of the method 400 may be performed by a processing system collectively comprising a plurality of devices as illustrated in FIG. 1 such as one or more of the servers 135, DB(s) 136, endpoint devices 111-113 and/or 121-123 (e.g., user equipment (UE), or the like), and so forth. In one example, the steps, functions, or operations of method 400 may be performed by a computing device or system 500, and/or a processing system 502 as described in connection with FIG. 5 below. For instance, the computing device 500 may represent at least a portion of a platform, a server, a system, and so forth, in accordance with the present disclosure. For illustrative purposes, the method 400 is described in greater detail below in connection with an example performed by a processing system. The method 400 begins in step 405 and proceeds to step 410.

At step 410, the processing system obtains a natural language request for a network topology visualization associated with a communication network. For instance, an example NL request may be: “show me a logical map of VMs that do not host a VFC or VNF.” Other example requests may be: “show me a map of RAN physical components for TAI ABC12345 with terrain overlay,” “for each PDU session establishment failure within the last 10 minutes associated with cell XYZ98765 show me a logical map of all network resources within two hops of any network resource identified as a root cause,” “show me a physical map of all links in network zone NE experiencing an overload condition between 1:00 PM and 2:00 PM, Tuesday,” “show me a physical map highlighting all links in network zone NE experiencing an overload condition between 1:00 PM and 2:00 PM, Tuesday with street map,” and so forth. In one example, the processing system may be deployed in the communication network.

In one example, the NL request for the network topology visualization comprises a request for a first type of network topology visualization from among a plurality of available types of network topology visualizations. For instance, the plurality of available types of network topology visualizations may include: a physical network map, a logical network map, a root cause network topology visualization, a network route map comprising one or more network routes, a layer 2 network map, a layer 3 network map, a network inventory map, and so forth. In one example, the NL request for a network topology visualization can be for a specific logical zone, subnet, tracking area (e.g., defined by tracking area code (TAC), tracking area identifier (TAI), or the like), a geographically bound area (e.g., a city/town, a zip code, a county, a state, or other geographically defined areas, e.g., two adjacent cities/towns, a geofenced area defined by a shape, polygon, or other bounding areas (e.g., freeform drawn, etc.)), and so forth. Similarly, in one example, the NL request for network topology visualization may specify certain physical or logical aspects of the communication network, such as routers, routers and links, border elements, MPLS routers (e.g., excluding non-MPLS routers, etc.), cellular network core components and/or cellular access network components, and so forth. For example, a physical network map may include physical network resources, such as routers, servers, line cards, racks, antennas, physical links (e.g., optical cables, coaxial cables, etc.), power supplies, etc. A logical network map may include logical resources, including virtual machines or containers, virtual network functions, logical links, such as tunnels, bearers, etc., network zones, sub-nets, or other logical groupings of network resources, and so forth. In one example, the natural language request may also include one or more options for the network topology visualization, e.g., to include or exclude an animation, to include or exclude a geographic map layer/element, a preferred zoom level, etc.

At 420, the processing system generates a prompt based upon the natural language request in accordance with a prompt mapping function. For instance, in one example, the prompt mapping function may comprise a term mapping function that matches terms in natural language requests to data fields of data tables of the database system. For instance, the data fields may comprise at least one of: table columns, or fields of data elements within a table column. To further illustrate, as noted above, the data elements may comprise JSON elements (e.g., and where the fields may comprise JSON fields). Alternatively, or in addition, the prompt mapping function may comprise a thesaurus/controlled vocabulary and/or an ontology. In one example, such a thesaurus and/or ontology may be maintained as a graph, or graph database. Alternatively, or in addition, nodes (in the ontology graph) may represent node types and/or link types in a network topology graph. In one example, the term mapping function may be updated via machine learning. For instance, as described above, feedback from users may be obtained to indicate whether search results are corrected in accordance with the intents of the respective natural language requests, which may be used as positive and negative examples for ongoing learning and/or periodic retraining.

In one example, a portion of the prompt relating to the type of visualization may be truncated from the output of the prompt mapping function before submission as input to a generative model at step 430 (e.g., show me a logical map of . . . ” may be removed from the request/prompt. In one example, an output of the prompt mapping function may be inserted into a prompt template to finalize the prompt for use in step 430. For instance, standardized prompt content may be prepended or appended and/or the output of the prompt mapping function may be inserted into a prompt template, such as “generate a query for the request: ______.” For instance, the output of the prompt mapping function may be: “retrieve virtual network functions that do not host a virtual function component or virtual network function.” In such an example, the final prompt may be: “generate a query for the request: retrieve virtual network functions that do not host a virtual function component or virtual network function.”

At step 430, the processing system applies the prompt as an input to a generative model to generate at least one query. In one example, the generative model may be implemented by the processing system (e.g., a generative MLM). In other words, the instructions/code of the algorithm of the generative model may be executed by the processing system. In various examples, and as discussed above, the generative model may comprise a language model, e.g., an LLM. For instance, an ML-based generative model used in the present examples may comprise a GAN, a BERT model, a GPT model, and SGPT model, a LLaMA model, a LaMDA model, a PaLM model, and so forth. In one example, step 430 may include generating supplemental prompt content from one or more data tables of the database system or from a graph database of a network topology, and applying the supplemental prompt content as an additional input to the generative model. For instance, step 430 may include a retrieval augmented generation (RAG) process. For example, supplemental prompt content may include data derived from the database system, such as the thesaurus/ontology, column and/or field labels, graph node types, graph edge types, permitted connection/edge types between node types, etc. Supplemental prompt content may also include domain knowledge, such as vectorized representations of white papers or other technical documents, textbooks, etc. Supplemental prompt content may also include specific documentation relating to graph database queries, SQL queries, or other query languages. For example, official descriptions, instruction manuals, or the like associated with query language commands, syntax, etc., sample queries, and so forth may be included as supplemental prompt content (and/or vectorized and included as supplemental prompt content). In any case, the output of the generative model may be a fully formed query, e.g., a graph database query (e.g., GraphQL, Gremlin, etc.) and/or SQL query, or the like. In one example, the output may include two or more queries to retrieve the relevant data via respective query language syntaxes from the respective data sources in the communication network database system. However, in another example, the at least one query may comprise a single query that may retrieve the relevant portions of data in graph database format and SQL-accessible format, respectively. In one example, step 430 may include defining weather data, vehicular traffic data, event data (e.g., for large entertainment events, political gatherings, etc.), and so on as filter criteria for extracting aspects of network topology data or other network operational data from the at least one query generated via step 430. For instance, a first query (or a first portion of a query) may retrieve weather data meeting certain criteria (e.g., a severe weather event). Then a second query (or a second portion of a single query) may retrieve the network topology data relating to a state of the communication network at the relevant time(s) as found in the extracted weather data.

At step 440, the processing system applies the at least one query to the communication network database system to obtain a query result. In one example, the processing system may further comprise the database system such that it processes/executes the query over a network topology graph database and/or one or more data tables in the communication network database system to generate the query result. In one example, the query result may comprise a result table. Alternatively, or in addition, the query result may comprise a sub-graph of a network topology graph. In one example, step 440 may include an application of the query via an API to the communication network database system. In one example, the query results may further include one or more of: weather data, retail data, vehicular traffic data, medical data, epidemiological data, and so on, in response to the at least one query.

At step 450, the processing system generates a network topology visualization of the query result. For instance, the network topology visualization may include one of: a physical network map, a logical network map, a root cause network topology visualization, a network route map comprising one or more network routes, a layer 2 network map, a layer 3 network map, a network inventory map, etc. In one example, step 450 may include mapping at least a portion of the natural language request to a particular network topology visualization type among the plurality of available types of network topology visualizations. In one example, the generating of the network topology visualization may include mapping at least a portion of the natural language request to a scope of the particular network topology visualization type, e.g., one or more configurable settings/parameters for the visualization, such as whether to include or omit geographic element/layer, a zoom level and so forth. In one example, the network topology visualization may include at least two network nodes and at least one network link between the at least two network nodes. However, in another example, links may be omitted (e.g., and the inventory shown without connections). In still another example, an inventory of physical links, e.g., optical other cables, and so forth, may be shown (e.g., without the nodes at the terminals of the respective links). Accordingly, in one example, the network topology visualization may include at least one geographic map component, such as a street map, a terrain map, a jurisdictional border map (which in one example may comprise additional data in one or more of the other map component(s)/layer(s)), etc. It should be noted that the term “component” may be used here to distinguish from an OSI or TCP/IP “layer,” such as used to refer to a “layer 3 router.” Thus, it should be understood that such a “component” may be a visual layer in the network topology visualization.

In one example, the network topology visualization may include at least one animation. For instance, such an animation may illustrate a change in the network topology itself, may illustrate a change in at least one network parameter or setting that is shown in animated form within the network topology visualization, may illustrate the occurrences of certain types of incidents over time, e.g., highlighting congested links in a time progression, highlighting overloaded routers or other physical or logical network elements in a time progression, and so forth. Similarly, in one example, such an animation may illustrate where VNFs are being instantiated or where VNFs are being decommissioned, disabled (e.g., placed in sleep mode), etc. In still another example, an animation may show levels of call volume, data volume, call establishments, call failures, call drops, etc. that may be color coded, or the like, and which may change in a time progression, and so forth. In one example, the network topology visualization may include a forecast of at least one network condition. For instance, the at least one network condition can be forecast volumes or rates of calls, data, call failures, call drops, a number of UEs served per cell/base station, sector, etc., and so forth. In one example, the forecast network condition(s) may be a forecast of one or more “network event(s),” e.g., forecast failures, forecast alert thresholds being reached for various performance indicators, etc. In one example, the forecasting may be ML-based in accordance with data in communication network database system, e.g., univariate or multivariate time series prediction/forecasting based upon past data and occurrences of past network events or past existence of network conditions. In one example, the forecasting may include or may account for forecast conditions external to the communication network, such as forecast weather, forecast vehicular/road traffic, etc.

In one example, step 450 may include determining a network event from the query result, generating a second query from the network event, and applying, the second query to the communication network database system to obtain a second query result. In such an example, the generating of the network topology visualization at step 450 may be based upon both the query result and the second query result. To further illustrate, the network event may be a hard failure, a soft failure, a partial failure, or at least one network performance indicator crossing an alert threshold. The network performance indicator may be for at least one network element/component (virtual or physical) or at least a portion of the communication network, e.g., a network zone, sub-net, tracking area, or other geo-fenced areas, or the like. In one example, the network event can include a root cause of a hard failure or silent failure, an overloaded network element, etc., which can then cause the network topology visualization to be focused on relevant portions of the network topology. In one example, the relevant portion could be selected automatically, or by default if not specified by the natural language request. Alternatively, the natural language request could specify how much of the network topology to include, e.g., one hop connections, two hop connections, or an entire network path affected by a root cause network element, all network paths affected (if multiple paths are impacted), etc. (where a path may include a network flow, a customer VLAN path, a customer circuit, a control channel path, etc.). In one example, step 450 may include presenting one or more overlay layers with weather data, vehicular traffic data, event data (e.g., for large entertainment events, political gatherings, etc.), and so on, which may be added as overlay layer(s).

In one example, the generating of the network topology visualization at step 450 may be via a second generative model that is configured to generate instructions in accordance with a network topology visualization platform (or may comprise the processing system implementing the same general generative MLM for generating the at least one query at step 430, but now tuned for generating instructions to a visualization tool via prompt enhancement and RAG). For instance, the network topology visualization platform may include a catalog of: a plurality of available types of network topology visualizations and a plurality of configurable parameters for the plurality of available types of network topology visualizations, such as a selectable zoom level, a selectable number of hops from one or more network resources to include in the visualization, an option to include or omit geographic element(s)/layer(s), road map element(s)/layer(s), and so forth. Thus, the processing system, via the (second) generative MLM, may infer intents from the NL query and may output visualization generation instructions to the network topology visualization tool/platform in accordance with the intents. In one example, step 450 may include applying a prompt to the second generative model in accordance with the natural language request for the network topology visualization along with supplemental prompt content associated with the network topology visualization platform. For example, step 450 may include retrieval augmented generation (RAG) so as to include additional inputs to the (second) generative MLM, such as an instruction manual for the network topology visualization tool/platform, API information, examples of instruction syntax, or the like. In one example, the RAG content may also include examples of natural language requests and intents. For instance, a network operator may generate positive examples (and/or negative examples) of NL requests for each available type of network topology visualization supported by the tool/platform, or the like. In one example, the (second) generative model may output an instruction to cause the network topology visualization platform to render the network topology visualization (where in one example, the processing system may include the network topology visualization platform). In one example, the instruction may be generated and applied in accordance with an API of a network topology visualization rendering component (e.g., a tool/platform that may be part of the processing system or external to the processing system).

At step 460, the processing system presents the network topology visualization via at least one display device. For instance, step 460 may include presenting the visualization via a user interface (e.g., a GUI) that is used to submit the NL request at step 410. For instance, the network topology visualization may be presented on a display device via a UI, such as UI 300 illustrated in FIG. 3 and described above. In one example, step 460 may include transmitting a file content of the visualization to a user device for presentation on a display screen. Following step 460, the method 400 ends in step 495.

It should be noted that method 400 may be expanded to include additional steps, or may be modified to replace steps with different steps, to combine steps, to omit steps, to perform steps in a different order, and so forth. For instance, in one example, the processing system may repeat one or more steps of the method 400, such as steps 410-460 for new NL network topology visualization request(s), steps 440-460 to re-execute the query and to obtain an updated result based upon new data that may be populated into a network topology graph and/or one or more data tables of the communication network database system, and so forth. In one example, the method 400 may include providing suggested NL network topology visualization requests/prompts prior to obtaining the NL network topology visualization request at step 410. In one example, the method 400 may include storing NL network topology visualization requests, prompts, and/or queries, e.g., along with query results for fast re-access. In one example, the method 400 may further include obtaining a selection of the communication network database system, e.g., from among a plurality of available communication network database systems. In one example, the method 400 may include obtaining feedback and retraining the prompt mapping function and/or the generative model(s). Alternatively, or in addition, the method 400 may include other pre- or post-processing operations, such as ETL operations, data cleansing, sanitizing, averaging, etc. In another example, the communication network database system may include, e.g., non-SQL datasets (or “no-SQL”), data stored in data graph form, and so forth, weather data, retail data, vehicular traffic data, medical data, epidemiological data, and so on. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not specifically specified, one or more steps, functions, or operations of the method 400 may include a storing, displaying, and/or outputting step as required for a particular application. In other words, any data, records, fields, and/or intermediate results discussed in the method 400 can be stored, displayed and/or outputted either on the device executing the method 400, or to another device, as required for a particular application. Furthermore, steps, blocks, functions, or operations in FIG. 4 that recite a determining operation or involve a decision do not necessarily require that both branches of the determining operation be practiced. In other words, one of the branches of the determining operation can be deemed as an optional step. In addition, one or more steps, blocks, functions, or operations of the above described method 500 may comprise optional steps, or can be combined, separated, and/or performed in a different order from that described above, without departing from the examples of the present disclosure.

FIG. 5 depicts a high-level block diagram of a computing device or processing system specifically programmed to perform the functions described herein. For example, any one or more components or devices illustrated in FIGS. 1 and 2, or described in connection with the examples of FIGS. 3 and 4 may be implemented as the processing system 500. As depicted in FIG. 5, the processing system 500 comprises one or more hardware processor elements 502 (e.g., a microprocessor, a central processing unit (CPU) and the like), a memory 504, (e.g., random access memory (RAM), read only memory (ROM), a disk drive, an optical drive, a magnetic drive, and/or a Universal Serial Bus (USB) drive), a module 505 for generating a network topology visualization from a query result obtained via applying a query generated via a generative model from a prompt in accordance with a natural language request, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 5, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 5 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for generating a network topology visualization from a query result obtained via applying a query generated via a generative model from a prompt in accordance with a natural language request (e.g., a software program comprising computer-executable instructions) can be loaded into memory 504 and executed by hardware processor element 502 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for generating a network topology visualization from a query result obtained via applying a query generated via a generative model from a prompt in accordance with a natural language request (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, a natural language request for a network topology visualization associated with a communication network;
generating, by the processing system, a prompt based upon the natural language request in accordance with a prompt mapping function;
applying, by the processing system, the prompt as an input to a generative model to generate a query;
applying, by the processing system, the query to a communication network database system to obtain a query result;
generating, by the processing system, the network topology visualization from the query result; and
presenting, by the processing system, the network topology visualization via at least one display device.

2. The method of claim 1, wherein the natural language request for the network topology visualization comprises a request for a first type of network topology visualization from among a plurality of available types of network topology visualizations.

3. The method of claim 2, wherein the plurality of available types of network topology visualizations includes:
a physical network map;
a logical network map;
a virtual private network topology map;
a network route impairment map;
a root cause network topology visualization;
a network route map comprising one or more network routes;
a layer 2 network map;
a layer 3 network map; or
a network inventory map.

4. The method of claim 1, wherein the network topology visualization includes at least two network nodes and at least one network link between the at least two network nodes.

5. The method of claim 1, wherein the network topology visualization includes at least one geographic map component.

6. The method of claim 1, wherein the network topology visualization includes at least one animation.

7. The method of claim 1, wherein the network topology visualization includes a forecast of at least one network condition.

8. The method of claim 1, wherein the generating of the network topology visualization includes:
determining a network event from the query result;
generating a second query from the network event; and
applying the second query to the communication network database system to obtain a second query result, wherein the generating of the network topology visualization is from both the query result and the second query result.

9. The method of claim 8, wherein the network event comprises:
a hard failure;
a soft failure;
a partial failure; or
at least one network performance indicator crossing an alert threshold.

10. The method of claim 1, wherein the generating of the network topology visualization includes mapping at least a portion of the natural language request to a particular network topology visualization type among a plurality of available types of network topology visualizations.

11. The method of claim 10, wherein the generating of the network topology visualization includes mapping at least a portion of the natural language request to a scope of the particular network topology visualization type.

12. The method of claim 1, wherein the generating of the network topology visualization is via a second generative model that is configured to generate instructions in accordance with a network topology visualization platform.

13. The method of claim 12, wherein the network topology visualization platform includes a catalog of:
a plurality of available types of network topology visualizations; and
a plurality of configurable parameters for the plurality of available types of network topology visualizations.

14. The method of claim 12, wherein the generating of the network topology visualization includes:
applying a prompt to the second generative model in accordance with the natural language request for the network topology visualization along with supplemental prompt content associated with the network topology visualization platform.

15. The method of claim 14, wherein the second generative model outputs an instruction to cause the network topology visualization platform to render the network topology visualization.

16. The method of claim 1, wherein the generative model comprises a large language model-based machine learning model.

17. The method of claim 1, wherein the applying of the prompt as the input to the generative model to generate the structured query further comprises:
generating supplemental prompt content associated with the communication network database system; and
applying the supplemental prompt content as an additional input to the generative model.

18. The method of claim 1, wherein the communication network database system comprises a network topology graph database.

19. A non-transitory computer-readable medium storing instructions which, when executed by a processing system including at least one processor, cause the processing system to perform operations, the operations comprising:
obtaining a natural language request for a network topology visualization associated with a communication network;
generating a prompt based upon the natural language request in accordance with a prompt mapping function;
applying the prompt as an input to a generative model to generate a query;
applying the query to a communication network database system to obtain a query result;
generating the network topology visualization from the query result; and
presenting the network topology visualization via at least one display device.

20. An apparatus comprising:
a processing system including at least one processor; and
a computer-readable medium storing instructions which, when executed by the processing system, cause the processing system to perform operations, the operations comprising:
obtaining a natural language request for a network topology visualization associated with a communication network;
generating a prompt based upon the natural language request in accordance with a prompt mapping function;
applying the prompt as an input to a generative model to generate a query;
applying the query to a communication network database system to obtain a query result;
generating the network topology visualization from the query result; and
presenting the network topology visualization via at least one display device.
